(19) United States
(12) Patent Application Publication
(10) Pub. No.: US 2013/0089085 A1
(43) Pub. Date: Apr. 11, 2013

(54) WIRELESS TRANSMISSION OF CONTENT SIMULTANEOUSLY ACCESSIBLE TO MULTIPLE USERS USING WI-FI INFRASTRUCTURE

(71) Applicants: Boaz Ben-Moshe, Herzliya (IL); Amit Dvir, Herzliya (IL); Eyal Berliner, Ramat Gan (IL)

(72) Inventors: Boaz Ben-Moshe, Herzliya (IL); Amit Dvir, Herzliya (IL); Eyal Berliner, Ramat Gan (IL)

(73) Assignee: ARIEL UNIVERSITY RESEARCH AND DEVELOPMENT COMPANY, LTD., Ariel, IL (US)

(21) Appl. No.: 13/703,353

(22) PCT Filed: Jun. 12, 2011
(86) PCT No.: PCT/IB2011/052551

§ 371 Date: Dec. 11, 2012

Related U.S. Application Data
(60) Provisional application No. 61/354,222, filed on Jun. 13, 2010.

(51) Int. Cl. H04W 40/24

(52) U.S. Cl. CPC H04W 40/244
USPC 370/338

(57) ABSTRACT

Disclosed are methods and devices for wireless transmission of content using Wi-Fi infrastructure to multiple user-devices devices that does not require maintaining a Wi-Fi session with each user-device.

### RELATED APPLICATION

The present application gains priority from U.S. Provisional Patent Application No. 61/354,222 filed 13 Jun. 2010, which is included by reference as if fully set forth herein.

### FIELD AND BACKGROUND OF THE INVENTION

The invention, in some embodiments, relates to the field of wireless transmission and more particularly, but not exclusively, to methods and devices relating to wireless transmission of content that is accessible to multiple users using Wi-Fi infrastructure.

Worldwide, many people wish to consume digital content on-the-go, using ever-advancing mobile devices such as smartphones and tablet computers. In accordance with this growing appetite, mobile network operators are constantly investing both in the quality and diversity of the provided content, as well as in the infrastructure required to support it.

A prominent technological challenge operators are regularly facing, with respect to the above, arises when the digital content is simultaneously consumed by a large number of people. Such is the case, for example, with streaming video from a live event or a mobile TV program, which many desire to consume via the wireless network at the same time. Particularly challenging is the case where many consumers of such video event are located within the same area, thereby are being all served by a limited number of network transceivers such as cellular telephony base stations (cell sites).

Typically, wireless network architecture is based on a user initiating a network connection to the network and, once a connection is established, receiving unicast data-packets using two-way communication. The resulting bandwidth overheard leads to a limit on the number of users that can simultaneously consume content transmitted over the same wireless network even when the content consumed is identical, e.g., the same streaming movie or event.

Further, wireless networks are typically configured having a bandwidth sufficient to provide the different users with different amounts of data: a few users consuming much data (e.g., streaming video) and many users with lower data requirements (e.g., email messages, viewing Internet websites). Often, a single network transceiver is not able to provide all of a large number of users with sufficient bandwidth for high data requirement uses, e.g., simultaneous consumption of streaming video by many users.

### SUMMARY OF THE INVENTION

The invention, in some embodiments thereof, relates to wireless transmission of content that, in some aspects, has advantages over known wireless transmission of content.

In some embodiments, the invention relates to wireless transmission of content that is simultaneously accessible to multiple users using Wi-Fi infrastructure.

In some embodiments, the invention relates to methods and devices that are useful for transmission of a relatively large volume of data, in some embodiments corresponding to multiple programs, for example multiple high-quality video programs, that is simultaneously accessible to multiple users using Wi-Fi infrastructure.

According to an aspect of some embodiments of the invention there is provided a method of wireless transmission of content using Wi-Fi infrastructure, comprising:

a) providing a wireless content transmitter (similar to a known Wi-Fi access point) configured for transmission of data-packets using Wi-Fi infrastructure; and

b) serially supplying a set of data-packets to the wireless content transmitter for wireless transmission, the set of data-packets constituting a program of content; and

c) the content transmitter serially wirelessly transmitting the data-packets of the set of data-packets using a Wi-Fi infrastructure, wherein:
prior to transmission of each data-packet of the set of data-packets, the wireless content transmitter adding a header to the data-packet, the header including a predetermined generic destination identifier allowing a plurality of user-devices to access the data-packet;
   thereby transmitting each data-packet of the set with the header.

According to an aspect of some embodiments of the invention there is also provided a device suitable for wireless transmission of content using Wi-Fi infrastructure, as described herein.

According to an aspect of some embodiments of the invention, there is also provided a method of receiving data-packets transmitted over a Wi-Fi infrastructure, comprising:

a) with a user-device, scanning Wi-Fi frequencies for Wi-Fi transmissions to identify beacon frames;

b) upon identifying a transmitted beacon frame, synchronizing the user-device with the transmitter of the beacon frame; and

c) subsequently to the synchronizing:
i. interrogating data-packets transmitted by the transmitter for the presence of a predetermined generic destination identifier; and
ii. if a transmitted data-packet includes a predetermined generic destination identifier, processing the data-packet to recover data therefrom without establishing a Wi-Fi session with the transmitter, where the data corresponds to content, for example video or audio content.

According to an aspect of some embodiments of the invention there is also provided a device suitable for wireless reception of content transmitted using Wi-Fi infrastructure, comprising a receiver for receiving content transmitted as described herein. In some embodiments, the device is devoid of a Wi-Fi transmitter. In some embodiments, the device comprises a Wi-Fi transceiver.

According to an aspect of some embodiments of the invention there is also provided a method comprising: providing a communication channel allowing access to software configured to allow a Wi-Fi enabled user-device to implement a method of receiving data-packets in accordance with the method as described herein.

Unless otherwise defined, all technical and scientific terms used herein have the same meaning as commonly understood by one of ordinary skill in the art to which the invention pertains. In case of conflict, the specification, including definitions, will control.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

As used herein, the indefinite articles “a” and “an” mean “at least one” or “one or more” unless the context clearly dictates otherwise.

In some instances, especially in the priority document, the term “content provider” is used as a synonym for “wireless content transmitter”, the terms “consumer device” and “consumer receiver device” are used as synonyms for “user-device” and the term “service provider” is used as a synonym for “operator”.

Some embodiments of the invention may involve performing or completing selected tasks manually, automatically, or a combination thereof. Some embodiments of the invention are implemented with the use of components that comprise hardware, software, firmware or combinations thereof. In some embodiments, some components are general-purpose components such as general-purpose computers or processors. In some embodiments, some components are dedicated or custom components such as circuits, integrated circuits or software. For example, some embodiments are performed, at least partially, as a plurality of software instructions executed by a data processor, for example which is part of a general-purpose or custom computer. In some embodiments, the data processor or computer comprises volatile memory for storing instructions and/or data and/or a non-volatile storage, for example, a magnetic hard-disk and/or removable media, for storing instructions and/or data. In some embodiments, implementation includes a network (e.g., Internet, Intranet, wired, wireless) connection. In some embodiments, implementation includes a user interface, generally comprising one or more of input devices (e.g., allowing input of commands and/or parameters) and output devices (e.g., allowing reporting parameters of operation and results).

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted are not to scale. In the Figures:

FIG. 1 is a schematic depiction of an embodiment of wireless transmission as described herein using a content transmitter;

FIG. 2 is a schematic depiction of an embodiment of wireless transmission as described herein using a content transmitter and a system receiver;

FIG. 3 is a schematic depiction of an embodiment of wireless transmission as described herein using a content transmitter and a single system client; and

FIG. 4 is a schematic depiction of an embodiment of wireless transmission as described herein using a content transmitter and eight system clients.

### DESCRIPTION OF SOME EMBODIMENTS OF THE INVENTION

The invention, in some embodiments thereof, relates to wireless transmission of content that, in some aspects, has advantages over known wireless transmission of content.

In some embodiments, the invention relates to wireless transmission of content that is simultaneously accessible to multiple users using Wi-Fi infrastructure. Some embodiments of the invention can be considered as broadcasting of content (especially video and audio content) using Wi-Fi infrastructure.

The principles, uses and implementations of the teachings of the invention may be better understood with reference to the accompanying description and figures. Upon perusal of the description and figures present herein, one skilled in the art is able to implement the teachings of the invention without undue effort or experimentation. In the figures, like reference numerals refer to like parts throughout.

Before explaining at least one embodiment of the invention in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

It is common for a person to carry a portable electronic user-device configured for wireless two-way communication such as a smartphone, computer, game console, media player or personal digital assistant. Such user-devices may be used for consumption of preloaded video (e.g., movies) and audio content that is stored locally, on a memory module of the user-device or on an external memory module accessible to the user-device.

Alternatively, many venues provide wireless two-way communication through a Wi-Fi wireless access point (typically as a component of a wireless router, sometimes as a stand-alone device functionally associated with a router), allowing a person having a Wi-Fi-enabled user-device to connect to the Internet to search for and access new content, such as audio and video content, including live-broadcast content.

Wi-Fi is the commonly used name for a wireless local area network based on the IEEE 802.11x standard. In Wi-Fi, wireless access points act as transceivers, providing local two-way radio frequency (2.4, 3.6 or 5 GHz) communication, usually to the Internet, to Wi-Fi-enabled user-devices. Wi-Fi access points typically have a range of up to about 30 meters (802.11b or 802.11g protocols) or about 60 meters (802.11n protocol).

Wi-Fi networks rely on two-way communication between the access point and each user-device to establish and maintain a Wi-Fi session with each such user-device.

During a Wi-Fi session with a specific user-device, the access point transmits content as a series of data-packets to the specific user-device.

Specifically, the access point continuously receives data-packets, for example from the Internet, for all the user-devices with which a Wi-Fi session is being maintained.

The access point serially wirelessly transmits the data-packets, each packet addressed to a specific user-device. Specifically, the access point adds a MAC header to each transmitted data-packet, the MAC header including an identifier addressing that packet to the specific user-device for which the data-packet is intended.

Each specific user-device with a maintained Wi-Fi session interrogates the MAC header of every packet received from the access point. Only those data-packets addressed to that user-device are accessed, that is to say, processed, for example, downloaded, stored and consumed, for example using a media player (e.g., Quicktime by Apple Corporation or Flash Player by Adobe Systems) and/or a browser (e.g., Windows® Internet Explorer by Microsoft Corporation, Firefox™ by the Mozilla Foundation, Google Chrome by Google Inc).

Additionally, the user-device transmits an acknowledgement of receipt for each received packet addressed to that user-device to the access point. If the access point does not receive an acknowledgement, the access point retransmits the same packet under the assumption that the original packet was not received.

It is important to note that Wi-Fi is typically used for two-way communication of content, that is to say, not only is content transmitted from the access point to user-devices (downloading), but user-devices also transmit content to the access point (uploading), in a manner analogous to that described above.

It is clear from the above description that quality of service from a given access point to an individual user-device at any given time is dependent on the amount of bandwidth required to initiate and maintain a Wi-Fi session with each of the user-devices, the amount of bandwidth required for content download from the access point to the user-devices, and the amount of bandwidth required for content upload from the user-devices to the access point. Consequently, there is a noticeable degradation in quality of service with increased number of users. When most or all of the user-devices require low bandwidth, for example, sending email messages or reading websites, the level of service is acceptable. However, when many users require high bandwidth, for example for simultaneous viewing of streaming videos, degradation of service quality (e.g., lag time, missed frames, poor video and audio quality) is noticeable. In any case, due to the overhead required to maintain any session, even for a session with low data volumes, the number of user-devices that can maintain a session with a given access point at any one time at a reasonable quality of service is limited.

Aspects of the methods and devices described herein relate to the wireless transmission of content that is simultaneously accessible to multiple user-devices using Wi-Fi infrastructure. Aspects relate to the reception of such transmitted content. Some embodiments of the invention can be considered as broadcasting content (especially video and audio content) using Wi-Fi infrastructure.

Typically, the teachings herein include the use of a wireless content transmitter (also called a content transmitter), substantially a modified Wi-Fi access point, to transmit one or more programs of content without establishing and maintaining Wi-Fi sessions with a user-device in order to transmit content to that user-device. Instead, the content transmitter transmits each program as a series of data-packets including a header, substantially similar to known Wi-Fi data frames, that are accessible to suitably-configured user-devices. Specifically, the data-packets transmitted by the content transmitter include a predetermined generic destination identifier. A suitably configured user-device is functional to interrogate transmitted data-packets and to access data-packets including a predetermined generic destination identifier.

Generally, in the method described herein the reverse channel (transmission to the content transmitter) is used relatively little if at all, so that significantly more bandwidth is available to the forward channel (transmission by the content transmitter) especially for content transmission, when compared to known Wi-Fi communication implementations.

In some embodiments, a virtually unlimited number of users can simultaneously access the transmitted content without substantially reducing the content transmission rate and service quality. Specifically, as in some embodiments no (or only a limited number, see below) Wi-Fi sessions are established and maintained, an increase in the number of user-devices accessing the transmitted content does not lead to a reduction of content transmission rate resulting from the increase in bandwidth overhead otherwise required to establish and maintain additional Wi-Fi sessions.

In some embodiments, higher-quality transmission of content and/or increased range is attained due to reduced noise in the area of transmission and/or increased time dedicated to the transmission of the content.

As in some embodiments no (or few, see below) Wi-Fi sessions are established and maintained and substantially no data is uploaded from user-devices to the wireless content transmitter, significantly more bandwidth is available for content transmission by the wireless content transmitter when compared to known Wi-Fi communication implementations. In some such embodiments the bandwidth available for content transmission is sufficient for transmission of multiple programs, including transmission of HD video content. As a result, in some embodiments, a relatively large volume of data, in some embodiments corresponding to multiple programs, for example multiple high-quality video programs, is transmitted and is simultaneously accessible to multiple user-devices.

Similarly, no or few Wi-Fi sessions and substantially no data upload means that fewer transmitters are active in the area (e.g., venue) where the wireless content transmitter, is transmitting, resulting in reduced noise in the Wi-Fi transmission frequencies and in fewer packet collisions, leading to a reduced incidence of packet corruption and packet loss, increasing quality of service and the bandwidth available for forward channel transmission.

In some embodiments, all (or at least some) user-devices are operated in a receive-only mode with no transmission. Some such embodiments provide a suitably-configured user-device with privacy as the user-device can access content using Wi-Fi without transmission that would betray the presence of the user-device. Some such embodiments also allow a user-device to save energy while accessing content: a suitably-configured device has no need for energy-intensive Wi-Fi as transmission. In some such embodiments, computing-capacity of a user-device otherwise used for transmission and maintaining a Wi-Fi session is freed, allows a given user-device to dedicate more computing-capacity for displaying received content, an exceptionally important factor when the content is HD video and/or the user-device possesses relatively modest computing-capacity. In embodiments where a user-device does not transmit but only passively receives the content transmitter transmissions, it is impossible to know the identity of the user, to know if and what content is being consumed, and even if the user is present at a given venue. The user-device of the user cannot be accessed for illicit purposes, such as identity theft.

### Method of Transmission

Thus according to an aspect of some embodiments of the invention, there is provided a method of wireless transmission of content using Wi-Fi infrastructure, comprising:

a) providing a wireless content transmitter configured for transmission of data-packets using Wi-Fi infrastructure;

b) serially supplying a set (typically a series) of data-packets to the wireless content transmitter for wireless transmission, the set of data-packets constituting a program of content; and

c) the content transmitter serially wirelessly transmitting the data-packets of the set of data-packets using Wi-Fi infrastructure, wherein:
prior to transmission of each data-packet of the set of data-packets, the wireless content transmitter adding a header to the data-packet, the header including a predetermined generic destination identifier that allows a plurality of user-devices to access the data-packet
   thereby transmitting each data-packet of the set of data-packets with the header.

Generally, the teachings herein are configured to make use, with some modification, of the existing (ubiquitous) Wi-Fi infrastructure including the commonly found Wi-Fi routers and access-points distributed in many venues, cheap and available Wi-Fi-enabled consumer devices such as mobile telephones, smartphones, PDAs and portable computers, as well as the proven and robust software infrastructure for implementing two-way wireless communication using Wi-Fi according to existing standards. Accordingly, in some embodiments, the teachings herein are preferably implemented on Wi-Fi software and/or hardware that has undergone relatively minor modifications to implement the teachings herein. A person having ordinary skill in the art of wireless communication, network communication and Wi-Fi is able, upon perusal of the description herein, to implement the teachings herein without undue effort, typically by modifying existing software code.

In known Wi-Fi communications, an access point adds a MAC header to each transmitted frame, the MAC header including a destination identifier (the identity of the user-device for which the packet is intended) in the address-1 field and a source identifier (the identity of the access point) in the address-2 field. In some embodiments of the invention, the header added by the content transmitter is preferably substantially analogous to a MAC header known in standard Wi-Fi communication, so that implementation of the content transmitter to add the generic destination identifier requires only minor changes to known Wi-Fi infrastructure. The predetermined generic destination identifier indicates that the data-packet is a data-packet in accordance with the teachings herein and is intended to be accessible to any suitably-configured user-device. The generic destination identifier is added in any suitable field of the header. In some embodiments, the generic destination identifier is added in the equivalent of the address-1 field of a MAC header. In some embodiments the generic destination identifier is added in the address-3 or address-4 field.

In some embodiments, a wireless content transmitter adds the same generic destination identifier to all transmitted data-packets and suitably-configured user-devices are configured to identify the generic destination identifier. In some embodiments, a wireless content transmitter adds a different generic destination identifier to different transmitted data-packets, so that to some data-packets a certain predetermined generic destination identifier is added and to other data-packets a different predetermined generic destination identifier is added, typically all the predetermined generic destination identifiers being selected from a pool (a limited set) including a plurality of predetermined generic destination identifiers.

In some embodiments, during the serial wireless transmission of the set of data-packets, the wireless content transmitter periodically transmits a beacon frame (analogous to that known in standard Wi-Fi communication), allowing suitably-configured user-devices and standard Wi-Fi-enabled devices to receive synchronization information allowing communication with the content transmitter.

In some embodiments, during the serial wireless transmission of the set of data-packets, the wireless content transmitter does not transmit a probe response to a probe request received from a user-device.

In some embodiments, during the serial wireless transmission of the set of data-packets, the wireless content transmitter does not transmit a positive association response to an association request received from a user-device, for example denies the association request or does not transmit any response.

A standard Wi-Fi-enabled device that is not suitably-configured for implementing the teachings herein identifies the transmissions from the content transmitter, in some embodiments, by receiving a beacon frame transmitted by the content transmitter, and attempts to establish a standard Wi-Fi session. The attempt to establish the Wi-Fi session fails, for example because no probe response is transmitted to the probe request or association request is ignored or denied. Such a standard Wi-Fi-enabled device can elect to seek an available access point, and if such is present, establish a standard Wi-Fi session in the usual way with that available access point.

For example, a suitably-configured user-device identifies the transmissions from the content transmitter, in some embodiments, after receiving a beacon frame transmitted by the content transmitter and synchronizing with the content transmitter.

In some embodiments, the fact that the transmissions from the content transmitter are in accordance with the teachings herein is noted in a beacon-frame, typically the usually unused portions of the beacon frame. In such embodiments, the user-device interrogates the appropriate portions of the beacon frame to identify the transmissions as being in accordance with the teachings herein, and then begins to interrogate headers of received data-packet for the presence of a generic destination identifier

In some embodiments, the user-device simply interrogates headers of received data-packets for the presence of a generic destination identifier.

If a generic destination identifier is present in the header of the received data-packet, the user-device begins to process received data-packets in substantially the usual way. The user-device interrogates received data-packets, and those data-packets that include the generic destination identifier are accessed, processed and consumed in the usual way, typically requiring downloading, local storage, processing to extract the relevant data corresponding to the content, combining relevant data from succeeding data-packets to assemble the program and display of the program using an appropriate viewer, such as a media viewer or browser.

In some embodiments, a suitably-configured user-device is also configured to function as a standard Wi-Fi-enabled device. If transmissions are not in accordance with the teachings herein, and there is no generic destination identifier present in the header of the received data-packets, the user-device understands that the beacon signal is from a standard Wi-Fi access point and optionally proceeds to establish a standard Wi-Fi session in the usual way. In some embodiments, the user of a suitably-configured user-device may optionally choose not to consume the content transmitted as described herein. and optionally, elect to seek an available access point, and if such is present, establish a standard Wi-Fi session in the usual way.

In some embodiments, a suitably-configured user-device is configured to be optionally operable in receive-only mode, that is to say, the device can function as a known Wi-Fi enable device transmitting and receiving, and allows a user to switch off the Wi-Fi transmission functionality while retaining the Wi-Fi reception functionality, allowing consumption of content in accordance with the teachings herein.

In some embodiments, a suitably-configured user-device is configured to be a receive-only device, that is to say, the device cannot transmit, but is configured to receive Wi-Fi-transmissions, for example in accordance with the teachings herein, allowing consumption of content in accordance with the teachings herein.

### Content

As used herein, the term ‘content’ refers to any content, but typically refers to audio and video content, especially video content such as movies, sporting events and broadcast new. As discussed in greater detail below, in some embodiments content also includes high-quality video content such as HD video. In some embodiments, transmitted content is “live” content, that is to say video or audio content that is captured using an appropriate device (e.g., a video camera) and transmitted in close to real time.

Some embodiments of the teachings herein are advantageously implemented for the transmission of a relatively large-volume of data, for example one or multiple concurrently-transmitted video programs, preferably high-quality video programs. In some embodiments, multiple programs are concurrently transmitted, for example, by interleaving data-packets relating to each program. In some embodiments, at least 2, at least 4, at least 6 and even at least 10 different programs are concurrently transmitted. In some embodiments, the number of programs transmitted is fixed. In some embodiments, the number of programs concurrently transmitted at any given time is changed, allowing fewer higher-quality programs to be concurrently transmitted or more lower-quality programs to be concurrently transmitted.

For example, some embodiments of the teachings herein allow transmission of multiple high-definition video programs (HDTV). For example, using a modified Wi-Fi access point configured for IEEE 802.11g (54 Mbps) transmission as a content transmitter in accordance with the teachings herein, 18 programs can be concurrently transmitted each allocated 3 Mbps bandwidth, or 9 programs can be concurrently transmitted each allocated 6 Mbps bandwidth, or 3 programs can be concurrently transmitted each allocated 18 Mbps bandwidth. For example, using a modified Wi-Fi access point configured for IEEE 802.11n (300 Mbps) transmission as a content transmitter in accordance with the teachings herein, 100 programs can be concurrently transmitted each allocated 3 Mbps bandwidth, or 30 programs can be concurrently transmitted each allocated 10 Mbps bandwidth, or 12 programs can be concurrently transmitted each allocated 25 Mbps bandwidth.

### Single and Multiple Programs

As used herein, the term ‘program’ is used as the term ‘channel’ in the art of television or radio transmissions, that is to say, content is transmitted as one or more programs, where each program constitutes a coherent set of content to be consumed by a person (typically, the user of a user device). In some embodiments, the teachings herein are implemented for the transmission of a single program, for example, a single movie at any one time. In some embodiments, the teachings herein are implemented for the simultaneous transmission of multiple programs, for example, multiple movies at any one time, each movie transmitted in a different program. In some embodiments, a user selects a program to access, and can then consume the content (e.g., a movie) transmitted on that program. All users who access the same program consume the same content at the same time. A user interested in consuming a different content than transmitted on a given program, selects a different program.

Thus, in some embodiments, the set of data-packets constitutes a single program. In some such embodiments, the data-packets constituting the single program are transmitted serially in order.

Thus, in some embodiments, the set of data-packets constitutes at least two subsets of data-packets, each subset of data-packets constituting a different program. In some such embodiments, the data-packets of a subset are transmitted serially in order, typically interleaved with transmission of data-packets of other subsets.

### Locally-Relevant Program

In some embodiments, at least one subset of data-packets constitutes a locally relevant program, including locally relevant information, for example, train and transportation schedules, weather information, maps (as images or data files, for example for navigation applications such as GPS) and the like.

### Program Guide

In some embodiments, the content transmitter also transmits a program guide that allows a user of a user-device to select a specific transmitted program for consumption, typically including information displayable to a user as to the number of programs available at a given time (e.g., currently, currently and in the future) as well as information that allows a suitably-configured user-device to select only the data-packets relevant to a selected program for processing and eventual display to a user.

In some embodiments, at least one subset of data-packets constitutes a guide program that serves as the program guide, providing the information allowing selection of a specific program for consumption. Such a program constitutes a TV guide as known in the art of television viewing, that provides a user with information, for example, the identity of the transmitted programs and what content is broadcast in each program, how to access the programs, scheduling information, trivia about content that is to transmitted in the programs and the like.

In some embodiments, a program guide is transmitted in unused capacity of beacon frames transmitted by the content transmitter. As is known in the art of Wi-Fi transmission, a Wi-Fi access point (and, in some embodiments, a content transmitter as described herein) transmits a beacon frame at a rate of between 100 Hz and 1 Hz, typically around 10 Hz, each beacon frame typically including about 30 bytes of unused capacity. In some embodiments, a content transmitter transmits a program guide, portion by portion, in the unused capacity of the beacon frames. Typically, in such embodiments each beacon frame includes a beacon frame serial number simplifying assembly of the data relating to a transmitted guide program.

For example, a content transmitter periodically transmits beacon frames including data relating to a program guide in the unused portions thereof. A standard Wi-Fi user-device not configured for receiving transmissions as described herein treats the beacon frames in the usual way and is unaffected by the presence of the program guide data. A suitably-configured user-device identifies the beacon frames transmitted by the content transmitter and uses the beacon frames, in substantially the usual way, to synchronize with the content transmitter. The user-device interrogates the usually-unused portion of the received beacon frames and identifies the presence of data relating to a program guide as described herein, including an identifier identifying the beacon frame as including a program guide, a total number of beacon frames making up a single complete program guide, the serial number of the specific beacon frames and the program guide data (e.g., in ASCII format). The user-device informs the user (e.g., on the user-device display screen) that content transmitted in accordance with the teachings herein is available. The user can elect not to receive and consume the content (indicating such in the usual way, e.g., using the device GUI) and, if available, optionally establish a session with an available access point if such exists in the usual way. Alternatively, the user elects to consume the content transmitted in accordance with the teachings herein. The user-device identifies the beacon frames transmitted by the content transmitter, downloading and storing the data relevant to the program guide. When possible (for example, when a full set of data is available, confirmed by comparing the beacon frame serial number with the total number of beacon frames making up the program guide), the user-device displays displayable portions of the program guide, for example on a display screen. The user selects a program to consume. From the program guide, the user-device identifies the information necessary to identify and process the data-packets relating to the selected program.

In some embodiments, program scheduling information and/or information required by a user-device to identify data-packets related to a selected program are not transmitted by the content transmitter. Instead, in some embodiments, such information is available through an alternative route.

For example, in some embodiments, some or all of the program guide information is found on a hardware device that is connectable with the user-device through a physical port, e.g., a USB port. A user acquires (e.g., purchases) the hardware device, connects the hardware device to the user-device and selects a program for consumption, substantially as described above.

For example, in some embodiments, some or all of the program guide information is found in printed form in a physical brochure or in a virtual Internet website. A user selects a program and inputs a code (e.g., using a GUI) that allows the user-device to identify and process the data-packets relating to the selected program.

### Content Supplier

The content transmitted by the content transmitter is supplied from any suitable content supplier functionally associated with the wireless content transmitter. Thus, in some embodiments the serial supplying of the set of data-packets to the content transmitter is by a content supplier. In some embodiments, the content supplier functions like a standard content supplier known in the field of Wi-Fi and Internet, and supplies the content as a series of data-packets, as known in the field of Wi-Fi.

In some embodiments, the content supplier comprises a remote content supplier and at least some of the content is non-local content. For example, at least some of the set of data-packets (typically at least one subset of data-packets as described above) is acquired from the Internet, for example, streaming video or streaming audio content. Such embodiments allow wireless broadcast of popular content from the Internet, for example, a popular sporting event supplied in real time in the Internet can be wirelessly transmitted to multiple user-devices.

In some embodiments, the content supplier comprises a local content supplier and at least some of the content is local content. For example, at least some of the set of data-packets (typically at least one subset of data-packets as described above) is locally available, for example from a local computer functionally associated with the content transmitter, the computer including data storage on which the content is stored. The computer retrieves content from the data storage as required, packetizes the content in the usual way, and serially supplies the data-packets to the content transmitter as required. For example, some such embodiments allow an operator to have a local television station, the operator having full control of the number of programs being transmitted and what content is transmitted, including advertisements and the like. In some such embodiments, the operator can decide on a desired or appropriate scheduling of programs that are transmitted. For example, an operator can select what content to transmit depending on the age, religion and background of the expected consumer. For example, an operator can schedule programs appropriately depending on date, time, local custom and local constraints, for example no programs during doctor visits in a hospital, or programs are scheduled to end when a train arrives at a station.

In some embodiments, an operator is able to transmit additional content (e.g., banners, on-screen warnings) during a program, for example, related to unexpected events, delays and reminders. In some embodiments, an operator is able to transmit advertisements in a program, for example during transmission of a movie or between the transmission of two movies, especially advertisement targeted to the viewer profile of a given program.

### Program Identifier

As noted above, in some embodiments a single program is transmitted at any one time.

In other embodiments, at least two programs are concurrently transmitted. In such embodiments, it is preferable to enable a user to select which of the at least two programs to consume.

Accordingly, in some embodiments a transmitted data-packet includes at least one program identifier. A program identifier identifies the program to which the data-packet relates, that is to say, the program of which the data-packet is a constituent part. In some such embodiments, a guide program includes a listing of the program identifiers. In some such embodiments, data-packets relating to a guide program include a program identifier that has a default value that is thereby easily identifiable.

For example, an embodiment of a content transmitter concurrently transmits three programs: movie1 where each related data package includes a program identifier of value X, movie2 where each related data package includes a program identifier of value Y and guide program where each related data package includes a program identifier of default value 0. Transmission of the corresponding data-packets is interleaved: a data-packet N of movie1, followed by a data-packet N of movie2, followed by a data-packet N of guide program, followed by a data-packet N+1 of movie1 and so one. A suitably-configured user-device that identifies the transmission of the content transmitter monitors each received data-packet and identifies the data-packets relating to guide program by interrogating the program identifier for the default value associated with the guide program. The data-packets corresponding to the guide program are processed as required and displayed to the user of the user-device, for example on a display screen. The user reads the guide program and sees that there is a possibility to view movie1, movie2 or the guide program. The user selects (for example, using an input device such as a mouse, a keyboard, a touchscreen), for example movie1. The user-device accepts the user selection and consults a look-up table that is a non-displayed part of guide program to retrieve the program identifier value X corresponding to movie1. The user-device then monitors each received data-packet and identifies the data-packets relating to movie1 by interrogating the program identifier for the value X associated with movie1. The data-packets corresponding to movie1 are subsequently processed as required and displayed to the user of the user-device, for example on a display screen.

In some embodiments, a data-packet supplied to the content transmitter includes a program identifier, that is to say, the program identifier is located in the data portion (non-header portion) of a transmitted data-packet. A disadvantage of such embodiments is that implementation generally requires that a user-device download and process all data-packets (including of programs that are not to be viewed) in order to interrogate the program identifier to identify the desired data-packets. Such embodiments are advantageous as the program identifier is added to the data-packets by an entity different than the content transmitter, allowing relatively less modification of the Wi-Fi infrastructure to implement the teachings herein. In some such embodiments, the program identifier is in the form of a port designation in the data content (TCP/UDP) layer. Specifically, as is known in the art of Wi-Fi communications, a portion (typically a lead-portion) of the data content layer of a transmitted data-packet includes a port designation allowing a user-device to send the data to the appropriate address in the user-device. In some embodiments of the method described herein, a specific port designation is associated with the data-packets of a single program. The user-device downloads and processes all of the data-packets transmitted by the content transmitter having the correct generic destination identifier, but only displays the data from data-packets having the port designation associated with a selected program.

In some embodiments, prior to transmission of each data-packet, the wireless content transmitter adds a program identifier to the header, so that the program identifier is located in the header of a transmitted data-packet. In such embodiments, the program identifier is added to any suitable field of the header. In some embodiments, the program identifier is added in the equivalent of the address-3 or address-4 field of a MAC header. Such embodiments are advantageous as a suitably-configured user-device is able to identify data-packets corresponding to a desired program by interrogating only the header and without requiring unnecessary processing of data-packets relating to programs that are to be viewed.

As noted above, in some embodiments a wireless content transmitter adds a different generic destination identifier to different transmitted data-packets. In some such embodiments, the generic destination identifier functions as a program identifier, that is to say, data-packets relating to the same program have the same generic destination identifier that is different from the generic destination identifier of data-packets relating to other programs.

In some embodiments, a data-packet includes a program identifier only in the data portion. In some embodiments, a data-packet includes a program identifier only in the header. In some embodiments, a data-packet includes a program identifier in both the data portion and in the header, in some such embodiments the same program identifier and in some such embodiments a different program identifier.

### Packet Serial Number

Standard Wi-Fi communication is based on a Send-and-Wait protocol, data frames are not lost because an access point is forbidden to transmit a succeeding data frame until an addressed user-device acknowledges receipt of a preceding data frame. In some embodiments of the method described herein, there is no knowledge whether a transmitted data-packet was received by one or more of multiple user-devices, and even if any user-device exists. In some embodiments it is useful for a user-device to know whether all transmitted data-packets have been received, or whether one or more data-packets have not been received.

Accordingly, in some embodiments at least some transmitted data-packet includes at least one data-packet serial number. Generally, a data-packet serial number indicates the order of that data-packet in the subset (and where relevant the set) of data-packets to which the data-packet belongs.

In some embodiments, a data-packet supplied to the content transmitter includes a packet serial number, that is to say, the packet serial number is located in the data portion of a transmitted data-packet.

In some embodiments, prior to transmission of each data-packet, the wireless content transmitter adds a packet serial number to the header, so that the packet serial number is located in the header of a transmitted data-packet. In such embodiments, the packet serial number is added to any suitable field of the header. In some embodiments, the packet serial number is added in the equivalent of the address-3 or address-4 field of a MAC header.

In some embodiments, a data-packet includes a packet serial number only in the data portion. In some embodiments, a data-packet includes a packet serial number only in the header. In some embodiments, a data-packet includes a packet serial number in both the data portion and in the header, in some such embodiments the same packet serial number and in some such embodiments a different packet number.

In such embodiments, a suitably-configured user-device monitors the packet serial number of received data-packets to ensure that a sufficient number of data-packets of a selected program are received. In embodiments where the content is video and/or audio content, the loss of even a relatively large proportion of data-packets still allows a user to consume the content, although in some instances with a noticeable loss of quality. In some embodiments, the user-device is configured to inform a user when the number of data-packets not received passes a certain threshold, for example a threshold where consumption of the content is no longer enjoyable. Such informing can include messages of an informative and/or practical nature such as “you are no longer able to view the program”, “please select an alternate program for viewing” or “please move closer to the content transmitter”.

### System Receiver

In some embodiments, the method further comprises:

providing at least one system receiver configured to wirelessly receive data-packets transmitted by the wireless content transmitter;
during the transmitting of the data-packets by the content transmitter, at least one of the system receivers receiving at least some of the data-packets; and
the system receiver reporting information relating to the quality of reception of the received data-packets,
wherein the reporting of the information is through a non-Wi-Fi modality.

Specifically, a system receiver is typically a Wi-Fi-enabled device located within range of the transmissions of the content transmitter. Such a system receiver is configured to receive transmissions from the content transmitter and report information about the received transmissions to the content transmitter, for example, reception quality, packet corruption and noise level. Such system receivers do not report the information in a Wi-Fi session, but through a non-Wi-Fi modality, for example, wired communication or wireless communication using a different radiation frequency, e.g., infrared, Bluetooth®, cellular telephony. The reported information is optionally used by the content transmitter to change transmission parameters and characteristics when insufficient quality of service is reported.

For example, in an exemplary embodiments a content transmitter is provided in a shopping mall together with a system receiver (a Wi-Fi-enabled smartphone) located in the shopping mall at a location that is to be the maximal range for which the operator of the content transmitter wants to provide a good quality of service. The content transmitter is operated in accordance with the teachings herein to concurrently transmit 10 programs, each comprising a HD movie.

The system receiver continuously monitors the data-packets transmitted by the content transmitter. When the quality of service falls below a predetermined threshold, for example 5% of transmitted data-packets are corrupted or unreceivable due to Wi-Fi transmissions from devices outside of the shopping mall, the system receiver informs the content transmitter through a non-Wi-Fi modality, for example by communication from the system receiver, through the cellular telephony system, and the Internet to the content transmitter. In response, the content transmitter can take action to improve the quality of service, for example, increase transmission power, transmit each data-packet in duplicate, triplicate or more, or change a forward-error correction algorithm implemented (see below). When the data-packets are transmitted multiple times, a suitably-configured user-device monitors the packet serial numbers and is able to ignore redundant data-packets.

In embodiments where data-packets are transmitted multiple times, a situation may occur where there is insufficient bandwidth available for transmission of content at a desired high quality. For example, as noted above the content transmitter originally concurrently transmits 10 video programs each comprising a HD movie. At some point in time, the background noise as reported by a system receiver increases so that it is decided to transmit each data-packet in triplicate, but there is insufficient bandwidth to transmit such a large amount of data. In some such embodiments, the content transmitter is configured to change the content transmitted to content requiring less band width, for example, one or more of the HD movies is replaced by the same movie in a lower-quality (i.e., non-HD) format.

### System-Client

In some embodiments, the method of wireless transmission described herein is implemented without maintaining two-directional Wi-Fi sessions. In such embodiments, the reverse channel is not used at all. In other embodiments, the method of wireless transmission described herein is implemented while maintaining a limited number of two-directional Wi-Fi sessions with one or more system-clients.

### No System-Client

In some embodiments, during the wireless transmission of content, the wireless content transmitter maintains no Wi-Fi sessions. As noted above, the reverse channel is not used and there is a large amount of bandwidth available for transmission of content. In some such embodiments, the content transmitter does not monitor Wi-Fi transmission but broadcasts substantially continuously, providing highest capacity broadcast, but substantially limiting the activity of other Wi-Fi access points in the vicinity. In some such embodiments, the content transmitter functions in accordance with standard Wi-Fi protocols to avoid collisions with other Wi-Fi access points and Wi-Fi user-devices associated therewith in the usual way. In some such embodiments, the content transmitter is provided information about quality of service by a system receiver as described above.

For example, in an embodiment a content transmitter concurrently transmits three programs: movie1, movie2 and guide program as described above, where each transmitted data-packet includes a program identifier and a packet serial number as well as a periodic beacon frames and, if needed, other control and/or management frames as required by the Wi-Fi infrastructure. The content transmitter does not monitor incoming transmissions and is not influenced by the presence of additional Wi-Fi transmitters, does not respond to probe requests or association requests, and is not aware of the existence of number of user-devices consuming the transmitted content.

A suitably-configured user-device identifies the transmission of the content transmitter by reception of a beacon signal and synchronizes thereby. The user-device consequently selects a program for consumption as described above. Packet serial numbers of a selected program are monitored to give the user-device a measure of quality of service.

### System-Client

In some embodiments, the method of wireless transmission described herein is implemented while maintaining a two-directional Wi-Fi session with each one of at least one system-client. In some such embodiments, the method of wireless transmission described herein is implemented while maintaining a single two-directional Wi-Fi session with a single system-client. In some embodiments, the method of wireless transmission described herein is implemented while maintaining at least two two-directional Wi-Fi session with at least two system-clients. A disadvantage of some such embodiments is that less bandwidth is available for content transmission due to the bandwidth required to maintain the Wi-Fi session or sessions. An advantage of such embodiments is that these are more similar to standard Wi-Fi communication methods so typically require less effort for implementation. An additional advantage is that the system-clients provides information to the content transmitter as to the quality of service that is better than the information provided by a system receiver as described above. That said, in some embodiments, a content transmitter receives information from at least one system-client and at least one system receiver as described above.

Accordingly, in some embodiments the method further comprises:

providing at least one system-client configured to wirelessly receive the data-packets transmitted by the wireless content transmitter;

during the transmission of content, the content transmitter maintains at least one Wi-Fi session with at least one of the system-clients; and

during the transmission of content, upon receipt of a transmitted data-packet by a system-client with a maintained Wi-Fi session, a system-client acknowledging receipt of the received data-packet, wherein the acknowledgment is performed as part of a Wi-Fi session between the system-client and the content transmitter.

Typically, during the wireless transmission, as little as possible bandwidth is allocated to maintaining the Wi-Fi session or sessions, leaving as much of the bandwidth as possible for transmission of content by the content transmitter.

In some embodiments, at least one system-client is a user-device functioning as an ad hoc system-client. Specifically, a random suitably modified user-device can function as the system-client. An advantage of such embodiments is that there is no need to provide a dedicated system-client or clients. A disadvantage is that such embodiments typically require agreement of the user of the user-device to function as a system-client: if no user-device is present or no user agrees that an own user-device be used as a system-client the method is not implemented.

In some embodiments, system-client comprises a dedicated entity, typically a suitably modified Wi-Fi enabled device.

In some such embodiments, there is only a single system-client, and during the wireless transmission of content the only Wi-Fi session the content transmitter maintains is with the single system-client.

In some embodiments, there are at least two system-clients, and during the wireless transmission of content the content transmitter maintains a Wi-Fi session with each one of the system-clients.

In some embodiments including a single system-client, the system-client is configured to maintain the Wi-Fi session substantially in the usual way according to the standard Wi-Fi protocol, but the system-client uses the generic destination identifier as an own identifier. In some such embodiments, the header added by the content transmitter is substantially similar to a known MAC header, the generic destination identifier (used as the recipient identifier, the system-client) is added to the equivalent of the address-1 field and the identifier of the content transmitter is added to the equivalent of the address-2 field.

In some embodiments including at least two system-clients, the system-clients are configured to maintain a Wi-Fi session with the content transmitter substantially in the usual way according to the standard Wi-Fi protocol, but each system-client uses a different generic destination identifier as an own identifier. In some such embodiments, the header added by the content transmitter is substantially similar to a known MAC header, the generic destination identifier (used as the recipient identifier, the system-client) is added to the equivalent of the address-1 field and the identifier of the content transmitter is added to the equivalent of the address-2 field. In some such embodiments, where each different generic destination identifier is used also as a program identifier, each system-client is dedicated to acknowledging data-packets relating to a single program.

In some embodiments including at least two system-clients, the system-clients are configured to maintain a Wi-Fi session with the content transmitter substantially in the usual way according to the standard Wi-Fi protocol, but the system-clients use a program identifier as an own identifier. In some such embodiments, the header added by the content transmitter is substantially similar to a known MAC header, the program identifier (used as the recipient identifier, the system-client) is added to the address-1 field, the generic destination identifier is added to the equivalent of the address-3 or address-4 field and the identifier of the content transmitter is added to the equivalent of the address-2 field. In such embodiments, each system-client is dedicated to acknowledging data-packets relating to a single program.

In some such embodiments, the one or more system-clients are configured to maintain the Wi-Fi session substantially in the usual way according to the standard Wi-Fi protocol, where each system-client uses an own identifier. In some such embodiments, the header added by the content transmitter is substantially similar to a known MAC header, the identifier of the system-client is added to the equivalent of the address-1 field, the identifier of the content transmitter is added to the equivalent of the address-2 field and the generic destination identifier is added to the equivalent of the address-3 or address-4 field. Some such embodiments are preferred as these require relatively minor changes to modify an existing Wi-Fi infrastructure to implement the teachings herein. In some such embodiments including at least two system-clients, the system-client identifiers are used as a program identifier.

In some embodiments, a system-client acknowledges receipt of all received Wi-Fi data-packets addressed to that system-client, similar to acknowledgment in a standard Wi-Fi session. In some such embodiments, the method becomes substantially a Send-and-Wait algorithm, the content transmitter sending a succeeding data-packet to a specific system-client only upon receipt of acknowledgment that the system-client received a previous data package addressed thereto.

For example, in an exemplary embodiment a content transmitter is provided in a shopping mall together with a single system-client (a Wi-Fi-enabled smartphone) located in the shopping mall at a location that is to be the maximal range for which the operator of the content transmitter wants to provide a good quality of service. The content transmitter is operated in accordance with the teachings herein to concurrently transmit 10 programs, each comprising a HD movie. The content transmitter establishes and maintains a Wi-Fi session with the system-client, where all data-packets of all ten programs are addressed to and transmitted to the single system-client within the framework of the Wi-Fi session. Transmitted data-packets for which no acknowledgment is received are retransmitted in accordance with the standard Wi-Fi protocol. Quality of service increases. If it is noticed that too many data-packets are being retransmitted, indicating a long-duration disruption of service, the content transmitter optionally takes additional action to improve the quality of service, for example as discussed with reference to a system receiver.

For example, in an exemplary embodiments a content transmitter is provided in a shopping mall together with ten system-clients (Wi-Fi-enabled smartphone) located in the shopping mall at various locations that are to be the maximal range for which the operator of the content transmitter wants to provide a good quality of service. The content transmitter is operated in accordance with the teachings herein to concurrently transmit 10 programs, each comprising a HD movie. The content transmitter establishes and maintains a Wi-Fi session with the system-client, where all data-packets of all ten programs are addressed to and transmitted to the single system-client within the framework of the Wi-Fi session, where the system-client identifiers are used as program identifiers. Transmitted data-packets for which no acknowledgment is received are retransmitted in accordance with the standard Wi-Fi protocol. Quality of service increases. If it is noticed that too many data-packets are being retransmitted, indicating a long-duration disruption of service, the content transmitter optionally takes additional action to improve the quality of service, for example as discussed with reference to the system receiver.

In order to reduce the bandwidth overhead required to maintain the Wi-Fi session, in some embodiments, the content transmitter expects acknowledgment of only a fraction (not all) of the transmitted data-packets, and the system-client acknowledges receipt of only received data-packets addressed to that system-client that the content transmitter expects acknowledgment of.

In some such embodiments, the fraction is a predetermined fraction of the received data-packets. In some embodiments, the predetermined fraction of the received data-packets are data-packets designated by the wireless content transmitter for receipt acknowledgment in the header.

In some such embodiments, prior to transmission of some data-packets, the wireless content transmitter adds an acknowledgment request tag to the header (e.g., in the address-3 or address-4 fields) of data-packets for which acknowledgment is expected.

In some such embodiments, the content transmitter expects acknowledgment of data-packets based on certain program identifiers (e.g., only data-packets relating to program 1 are expected to be acknowledged) or on certain packet serial numbers (e.g., only data-packets having a packet serial number that is a multiple of 8).

For example, in an exemplary embodiment a single content transmitter is provided in a shopping mall together with a system-client (a Wi-Fi-enabled smartphone) located in the shopping mall at a location that is to be the maximal range for which the operator of the content transmitter wants to provide a good quality of service. The content transmitter is operated in accordance with the teachings herein to concurrently transmit 10 programs, each comprising a HD movie. The content transmitter establishes and maintains a Wi-Fi session with the single system-client, where all data-packets of all ten programs are addressed to and transmitted to the system-client within the framework of the Wi-Fi session. The content transmitter expects acknowledgment of only data-packets relating to program 1 that have a packet serial number that is a multiple of 8. The system-client interrogates the program identifier and packet serial number of all received data-packets. The system-client acknowledges receipt of all received data-packets having a program identifier of 1 and a packet serial number that is a multiple of 8. If it is noticed that too many data-packets that are expected to be acknowledged are not being acknowledged, the content transmitter optionally takes action to improve the quality of service, for example as discussed with reference to the system receiver.

As noted above, in some embodiments the teachings herein are implemented using more than one system receiver and/or more than one system client. In some embodiments, the system receivers and/or system clients are located proximal to one physical location, in some embodiments near a border of the area where it is desired to provide a reasonable quality of service. In some embodiments, the system receivers and/or system clients are located at different physical locations in order to provide more detailed information about quality of service.

### Forward Error Correction

In standard Wi-Fi communication methods, content integrity is maintained by the user-device acknowledging the receipt of data-packets, leading to retransmission of lost or corrupted data-packets. Such methods guarantee that the data is transmitted with no error, but requires that the access point maintains a dialogue in the form of a Wi-Fi session with each user-device. As a result, the time allocated to the forward channel for data transmission from the access point to the user-devices is limited, both for the overhead required for maintaining the sessions and avoiding collisions, even without accounting for the required retransmissions of data-packets.

As discussed above, in some embodiments of the methods described herein it is desired to reduce or even eliminate transmissions from user-devices to the content transmitter (the functional analogue to the access point in a standard Wi-Fi communication method) in order to maximize the time available to the content transmitter for content transmission. Thus, some embodiments of the teachings herein are directed primarily to transmission of audio and video content (as opposed to, e.g., data content such as documents) so that the content can be consumed even when a relatively significant portion, e.g., even 5%, of data-packets are lost or corrupted.

That said, in some embodiments, the method described herein implements forward-error correction (FEC), that is to say, at least some data-packets transmitted by the content transmitter include error-correcting code. Any suitable FEC-algorithm may be used to generate the error-correcting code, e.g., FEC algorithms such as AN, BCH, Constant-weight, Convolutional, Group, Golay, Goppa, Hadamard, Hagelbarger, Hamming, Lexicographic, Long, LT, Online, Raptor, Reed-Solomon, Reed-Muller, Repeat-accumulate, Repetition, Tornado, Turbo code and Walsh-Hadamard.

Thus, in some embodiments the method further comprises, implementing forward-error correction so that at least some of the transmitted data-packets optionally include error-correcting code.

In some embodiments, a FEC algorithm is applied by the content transmitter to supplied data-packets that are to include an error-correcting code. In some embodiments, some of the data-packets supplied to the content transmitter include the error-correcting code of an applied FEC algorithm.

In some embodiments, a FEC algorithm is applied to the entire data portion of a data-packet, that is to say, excluding the header added by the content transmitter.

In some embodiments, a FEC algorithm is applied to only a part of the data portion of a data-packet. Such embodiments are exceptionally useful where a program identifier and/or packet serial number are in the data portion of a data-packet (as opposed to in the header): in such cases the FEC algorithm is preferably applied to portions of the data-packet not including the program identifier and/or packet serial number, making these readable (and identifiable) without requiring decoding.

### Fixed FEC

In some embodiments the implemented FEC is fixed FEC, that is to say, during transmission the same FEC algorithm is applied to all the transmitted data-packets relating to the same program in substantially the same way. In some such embodiments, an suitably-configured user-device includes the ability to decode received data-packets including the error-correcting code, and correct eventual errors if such exist.

In some such embodiments, the FEC-algorithm is predetermined, and suitably-configured user-devices are pre-configured to decode received data-packets.

For example, in an exemplary embodiment, a specific predetermined FEC-algorithm is always applied to transmitted data-packets. A suitably-configured user-device simply decodes the received data and applies error-correction, if needed, automatically as part of the processing of received data-packets.

In some such embodiments, the identity of a FEC-algorithm applied to the data-packet is designated in the header added by the content transmitter and/or designated in a portion of the data-packets that is readable without requiring decoding. By “identity of the FEC-algorithm” is meant, for example, the use of a FEC-algorithm (yes/no) and/or the identity of the specific FEC algorithm used and/or parameters thereof. Accordingly, in some embodiments, the method further comprises: prior to transmission of each data-packet of the set, the content transmitter adding a FEC identifier to the header, typically in the address-3 or address-4 field, thereby designating the identity of a FEC-algorithm applied to that data-packet.

For example, in an exemplary embodiment, a content transmitter is configured to apply none or one of seven FEC algorithms to transmitted data-packets in accordance with operator instructions and suitably-configured user-devices are configured to decode data-packets to which one of the seven FEC algorithms has been applied. An operator decides and selects (from a look-up table) to which of the transmitted programs to apply FEC and which FEC algorithm (e.g., more or less aggressive) to apply. During operation, the content transmitter applies or does not apply FEC to supplied data-packets prior to transmission thereof in accordance with the instructions received from the operator. The content transmitter additionally adds an appropriate FEC-identifier to each transmitted packet as a number with a value (e.g., between 0 and 7) in the address-4 field, where each value indicates the applied FEC algorithm (0=no FEC, 1-7 a specific FEC algorithm with specific parameters). A suitably-configured user-device receives the transmitted data-packets relating to the selected program as described above and retrieves the FEC-identifier from the header. Consulting a look-up table, the user-device identifies the applied FEC-algorithm from the FEC-identifier and uses an appropriate decoding algorithm to decode the data-packets, and if required, correct data errors.

### Dynamic FEC

In some embodiments, the method as described herein applies FEC dynamically, that is to say, the content transmitter is configured to optionally change the identity of a FEC algorithm applied to one or more data-packets, for example, as a result of an operator decision or due to some measure of actual quality of service (e.g., as measured by one or more system receivers or one or more system-clients). Typically, the content transmitter identifies that non favorable transmission conditions lead to more collisions, more noise, or more non-received data-packets so that the quality of service is below a desired threshold. Instead of or in addition to steps taken as described above, a more aggressive FEC algorithm is applied to data-packets to be transmitted, increasing quality of service. When the content transmitter identifies that the transmission conditions have improved, a less aggressive or no FEC algorithm is applied. Accordingly, in some embodiments, the forward-error correction is dynamic, and in such embodiments, the FEC algorithm applied to the data-packets optionally changes during transmission of the set of data-packets, for example in response to changing transmission conditions, e.g, identified with a system-client or system receiver.

### Encryption

In some embodiments, the data-packets are transmitted by the content transmitter in a non-encrypted fashion so that any suitably-configured user-device can be used to consume the transmitted content.

In some embodiments, some or all of the data-packets are encrypted prior to transmission, so that the data of transmitted data-packets are unreadable but the header added by the content transmitter remains unencrypted and readable. Any suitable encryption algorithm may be used for encrypting the data-packets, for example public-key encryption.

Accordingly, in some embodiments the method further comprises implementing encryption so that at least some of the transmitted data-packets are optionally encrypted. In some embodiments, prior to transmission of the data-packets that are to be encrypted, an encryption algorithm is applied to a data-packet thereby encrypting the data-packet. In some embodiments, the content transmitter is configured to and encrypts at least some of the transmitted data-packets. In some embodiments, the data-packets supplied to the wireless content transmitter are encrypted.

In some embodiments, all transmitted data-packets are encrypted so that user-devices not having the correct decryption code cannot be used to consume any of the transmitted content. Such embodiments allow an operator of the method as described herein to limit the users who can consume some or all of the transmitted content, for example, limited to paying user.

In some embodiments, the identification of the application of encryption to a specific data-packet is designated by an encryption identifier in the header added by the content transmitter, substantially equivalently to the FEC identifier as discussed above. Accordingly, in some embodiments, the method further comprises: prior to transmission of a data-packet of the set, the content transmitter adding an encryption identifier to the header, typically in the address-3 or address-4 field, thereby designating the identity of an encryption-algorithm applied to that data-packet in order to implement the encryption.

In some embodiments, a decryption code is provided on hardware, for example a USB dongle, for example distributed to certain people (e.g., people who rent a room in a hotel where the method is implemented) or purchased. In some embodiments, a decryption code is a code that is downloaded to the user-device (e.g., from the Internet) or entered to the user-device through a user-interface (e.g, keyboard, touch-screen).

In some embodiments, some or all of the data-packets corresponding to a specific program are encrypted so that user-devices not having the correct decryption code cannot be used to consume that specific program, but can be used to consume a program for which corresponding data-packets are not encrypted. For example, a guide program is typically not encrypted and freely-accessible to any suitably-configured user-device. A person views the guide program using a suitably-configured user-device and decides to consume one of the other, encrypted, programs. The person is able to request a decryption key from the operator of the method, for example, to buy a decryption key.

### Compression

In some embodiments, the data-packets are transmitted by the content transmitter in a non-compressed format.

In some embodiments, the data-packets are transmitted by the content transmitter in a compressed format, that is to say, a compression algorithm is applied to data in the data-packets. In some embodiments, the compression is lossless compression, e.g. avi. In some embodiments, the compression is robust compression, e.g. MPEG4, so that loss of data-packets results in degradation of the program quality rather than rendering the program undecipherable. In some embodiments, a program is transmitted with aggressive compression, e.g. H264 codec.

Accordingly, in some embodiments the method further comprises implementing compression so that at least some of the data transmitted data-packets are optionally compressed.

In some embodiments, the identification of the application of compression to data-packets relating to a specific program is designated by a compression identifier in the header added by the content transmitter, analogously to the FEC identifier or encryption identifier as discussed above. Accordingly, in some embodiments, the method further comprises: prior to transmission of a data-packet of the set, the content transmitter adding a compression identifier to the header, typically in the address-3 or address-4 field, thereby designating the identity of a compression algorithm applied in order to implement data compression.

### Transmission Devices

The methods described herein may be implemented using any suitably-configured transmission device.

Typically, a suitably-configured transmission device is a known Wi-Fi access point that has been modified by a person having ordinary skill in the art upon perusal of the description herein. In some embodiments, such modification includes and is even limited to modification of processor commands (e.g., software or software equivalents). In some embodiments, such modification includes modification of hardware, for example, functional association with a device such as a custom or general-purpose computer to implement features such as encryption or forward-error correction or to act as a content supplier to supply the content transmitter with the set of data-packets.

Thus, according to an aspect of some embodiments of the invention there is also provided a device suitable for wireless transmission using Wi-Fi infrastructure, comprising a wireless content transmitter for wirelessly transmitting content in accordance with the described herein. In some such embodiments, the wireless content transmitter is configured to:

serially receive a set of data-packets constituting a program of content; and

serially wirelessly transmit the data-packets of the set of data-packets using a Wi-Fi infrastructure,

wherein the wireless content transmitter is configured to, prior to transmission of each data-packet of the set of data-packets, add a header to the data-packet, the header including a predetermined generic destination identifier allowing a plurality of user-devices to access the data-packet.

### Method of Receiving Data-Packets

According to an aspect of some embodiments of the invention, there is also provided a method of receiving data-packets transmitted over a Wi-Fi infrastructure as described herein. In some embodiments, the method comprises:

a) with a user-device, scanning Wi-Fi frequencies for Wi-Fi transmissions to identify beacon frames;

b) upon identifying a transmitted beacon frame, synchronizing the user-device with the transmitter of the beacon frame (e.g., a Wi-Fi access point or a content transmitter as described herein);

c) subsequently to the synchronizing:
i. interrogating data-packets transmitted by the transmitter for the presence of a predetermined generic destination identifier; and
ii. if a transmitted data-packet includes a predetermined generic destination identifier, processing the data-packet to recover data therefrom (e.g., for display of content in the data-packets as described herein) without establishing a Wi-Fi session with the transmitter.
   In some embodiments, the method further comprises:

interrogating a data-packet transmitted by the transmitter for the presence of a program identifier; and

if the data-packet includes a desired program identifier, processing the data-packet to recover data therefrom.

In some embodiments, the method further comprises:

interrogating a data-packet transmitted by the transmitter for the presence of a packet serial number; and

if the data-packet includes a packet serial number indicating that the data in the data-packet has already been received for processing, ignoring the data-packet.

In some embodiments, the method further comprises: the processing of a data-packet includes decoding data that has been encoded using a FEC algorithm. In some such embodiments, the method further comprises:

interrogating a data-packet transmitted by the transmitter for the presence of a FEC identifier; and

selecting a method for decoding the data based on the identity of the FEC identifier.

### User-Devices

The methods described herein may be implemented using any suitably-configured user-device, e.g., Wi-Fi enabled cellular telephones, smartphones, computers, PDAs, game consoles and electronic tablets. suitably-configured includes configuration to receive and decipher the data-packets transmitted from the content transmitter.

Typically, a suitably-configured transmission device is a known Wi-Fi enabled device that has been modified by a person having ordinary skill in the art upon perusal of the description herein. In some embodiments, such modification includes and is even limited to modification of processor commands (e.g., software or software equivalents). In some embodiments, appropriate configuration includes the installation of software (e.g., a “media player”) for implementing the method described herein. Such software generally includes modules for providing a GUI on the user-device display screen, a module for intercepting the transmitted content, and a module for displaying the data to the user, e.g., includes a video/audio player or activates a video/audio player. In some embodiments, the software is physically provided on external media, for example, a disk, memory card or other recorded media. In some embodiments, the software is downloaded wirelessly from the Internet or from a local storage location.

In some embodiments, a user-device comprises a Wi-Fi transceiver, but is software-configured (or software-equivalent configured) to receive and decipher the data-packets transmitted from the content transmitter. For example, an appropriate software program is provided on removable media or through the Internet. In some embodiments, a standard Wi-Fi-enabled device is configured as a user-device by association with a hardware component, e.g., through a USB port.

In some embodiments, a user-device comprises a Wi-Fi receiver and cannot transmit Wi-Fi or establish a Wi-Fi session even in the presence of a suitable access point. In some embodiments, a standard Wi-Fi enabled device including a display screen is configured as a user-device (e.g., by association with a hardware component through a port such as a USB port) with a receive-only component comprising a Wi-Fi receiver and software allowing receiving of the content transmitter transmissions as described herein. Such embodiments are advantageous as a receive-only component is cheap to manufacture and uses little power during operation.

In some embodiments, a user-device is configured to scan the Wi-Fi channels (e.g., by passive sniffing) and to identify data-packets transmitted in accordance with the teachings herein without any Wi-Fi transmissions. An advantage of such embodiments is that a user can access a transmitted program without having to be identified and without generating noise.

As is clear to a person having ordinary skill in the art, one preferred method of configuring a known Wi-Fi enabled device to be suitably-configured to implement the teachings herein includes downloading and installing software that adds functionality or changes known Wi-Fi functionality. Thus, according to an aspect of some embodiments of the invention there is also provided a method comprising: providing a communication channel allowing access to software configured to allow a Wi-Fi enabled user-device to implement a method of receiving data-packets as described herein, In some embodiments, upon receipt of a command, the software is transferred to a designated location (e.g., a postal address, an IP address, a specific Wi-Fi enabled user-device). In some embodiments, the transferring is contingent upon receiving payment. In some embodiments the communication channel comprises an Internet communication channel, and/or a cellular telephony communication channel (“app store”), and/or a physical memory device configured to physically connect to a Wi-Fi enabled device (e.g., a CD, DVD, flash memory)

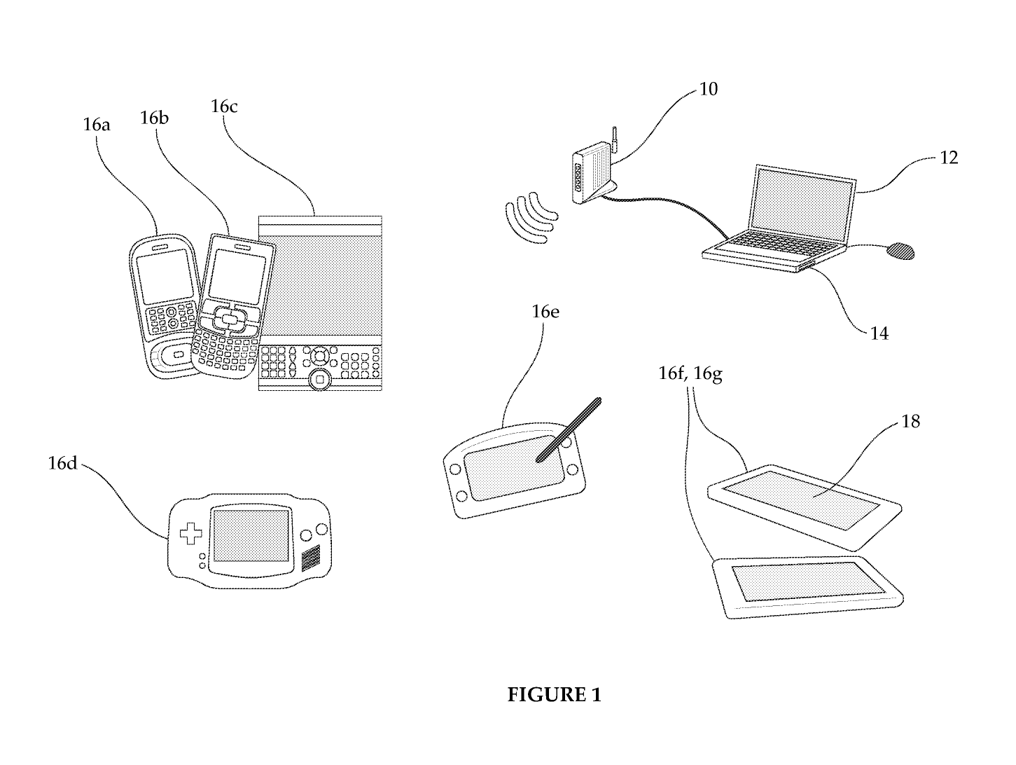

An exemplary embodiment of the teachings herein is described with reference to FIG. 1. Wireless content transmitter 10 is a Wi-Fi access point (e.g., Linksys WAP54G 802.11g) configured for implementing the teachings herein functionally associated with an appropriately modified general-purpose computer 12 (for example, Qosmio X505-Q879 from Toshiba, Minato, Tokyo, Japan including a processor and data-storage components, e.g., a hard disk 14) configured to function as a local content supplier. Content transmitter 10 is located in a venue, e.g., a train, a shopping mall, a hospital, a neighborhood, a hotel or a cruise ship.

Stored on hard disk 14 of computer 12 is the content to be transmitted, seventy movies in both standard format and HD (high-definition) format.

An operator makes seven programs (programs 1 through 7), each program in two versions normal and HD, including ten of the seventy movies, where interspersed between any two movies are advertisements for various goods and services. The operator makes an additional guide program (program 0) including “displayable content” such as scheduling information and trivia about the seventy movies, and “not displayable content”, instructions for a user-device as how to select a specific program.

The operator activates content transmitter 10 and computer 12 to implement the teachings herein. In the usual way, computer 12 retrieves sections of each one of the HD versions of the eight programs, packetizes the programs to generate data-packets, and then serially supplies the data-packets to content transmitter 10. The data-packets corresponding to the programs are supplied interleaved, that is to say, as a series of transmission cycles, wherein in each transmission cycle a single data-packet of each one of the eight programs is supplied to content transmitter 10. Each data-packet is supplied with a program identifier and a packet serial number.

Content transmitter 10 serially receives each data-packet and adds a header (substantially similar to a standard Wi-Fi MAC header) to the data-packet, the header including a predetermined generic destination identifier in the address-1 field, an own identifier in the address-2 field, the packet serial number of the data-packet in the address-3 field and a program identifier in the address-4 field.

In the usual way, content transmitter 10 serially transmits each data-packet with the added header, as well as control and/or management frames as required by the Wi-Fi standard, including periodic beacon frames. Content transmitter 10 does not monitor incoming transmissions and is not influenced by the presence of additional Wi-Fi transmitters, does not respond to probe requests or association requests, and is not aware of the existence of number of user-devices 16 consuming the transmitted content. In some embodiments, content transmitter 10 monitors Wi-Fi transmissions by Wi-Fi access points and Wi-Fi enabled devices maintaining sessions therewith and avoids collisions in substantially the usual way substantially in accordance with the Wi-Fi standard.

A suitably-configured user-device 16 (such as any of user-devices 16a to 16g) identifies the transmissions of content transmitter 10 by reception of a beacon signal and synchronization thereby. User-device 16 identifies the transmissions as transmissions in accordance with the teachings herein by the presence of the generic destination identifier in the address-1 field of the data-packet header and therefore does not attempt to initiate a Wi-Fi session with content transmitter 10. Instead, user-device 16 automatically informs the user (e.g., by a tone, a vibration, and/or a pop-up message on a touch screen 18) that content for consumption is available in accordance with the teachings herein.

A user of a user-device 16 interested in consuming the content indicates such through touch screen 18.

User-device 16 begins to automatically downloads and processes data-packets including a program identifier “0” in the address-4 field, corresponding to the guide program, processing including display of the guide program on touch screen 18.

The user watches the guide program and selects one of the seven movie programs, e.g., by entering a command through touch screen 18.

User-device 16 consults the “not displayable content” in the guide program for the program identifier corresponding to the selected program, e.g. “3”. User-device 16 thereafter proceeds to automatically download and process data-packets including a program identifier “3” in the address-4 field, corresponding to the selected program, processing including display of the movie transmitted on the program on touch screen 18.

A practically unlimited number of user-devices 16 that are located within the transmission range of content transmitter 10 are able to simultaneously receive, download and view any one of the eight programs transmitted by content transmitter 10.

In a related embodiment, the operator wants to make additional income from the transmissions. In such embodiments, programs 1 to 7 are encrypted using a suitable encryption algorithm. The encryption algorithm is applied by computer 12 so that content transmitter 10 receives the packets in encrypted form. Through the guide program, a user of a user-device 16 is informed the cost of and how to purchase a decryption key, for example, to go to a physical service location or a virtual service on the Internet and purchase a decryption code that can be input to user-device 16. As part of the processing of downloaded data-packets, user-device 16 decrypts the data-packets using the decryption code. The operator optionally occasionally changes the decryption code, for example once a day. In some related embodiments, the encryption algorithm is applied by content transmitter 10 to data-packets received from computer 12.

In a related embodiment, the operator wants to increase the quality of service by application of forward-error correction by application of a suitable FEC algorithm to all transmitted data-packets, optionally in addition to encryption. The FEC algorithm is applied by computer 12 so that content transmitter 10 receives the packets already including error-correcting code. All suitably-configured user-devices are aware of application of FEC and are configured to decode received data-packets, and if needed correct errors. As part of the processing of downloaded data-packets, user-device 16 decodes the data-packets using the appropriate decoding algorithm. In some related embodiments, the FEC algorithm is applied by content transmitter 10 to data-packets received from computer 12.

In related embodiments, content transmitter 10 and/or computer 12 are configured to apply one of a group (e.g., ten) different FEC algorithms listed in a predetermined look-up table, as selected by an operator. Whenever desired, the operator selects the FEC algorithm to be applied, and content transmitter 10 adds the appropriate FEC identifier to the added header, for example in the address-4 field. All suitably-configured user-devices include a look up table correlating a FEC identifier with an appropriate decoding algorithm, and are configured to decode received data-packets with the appropriate decoding algorithm and, if needed, correct errors therewith. As part of the processing of downloaded data-packets, user-device 16 decodes the data-packets using the appropriate decoding algorithm with reference to the FEC identifier in the address-4 field.

In related embodiments, the program identifier is not added to the header but instead added in the data portion of each data-packet. Such embodiments are implemented in a substantially similar way, but require downloading, storage and some processing of all data-packets to identify which data-packets correspond to the program selected for consumption by the user of the user-device.

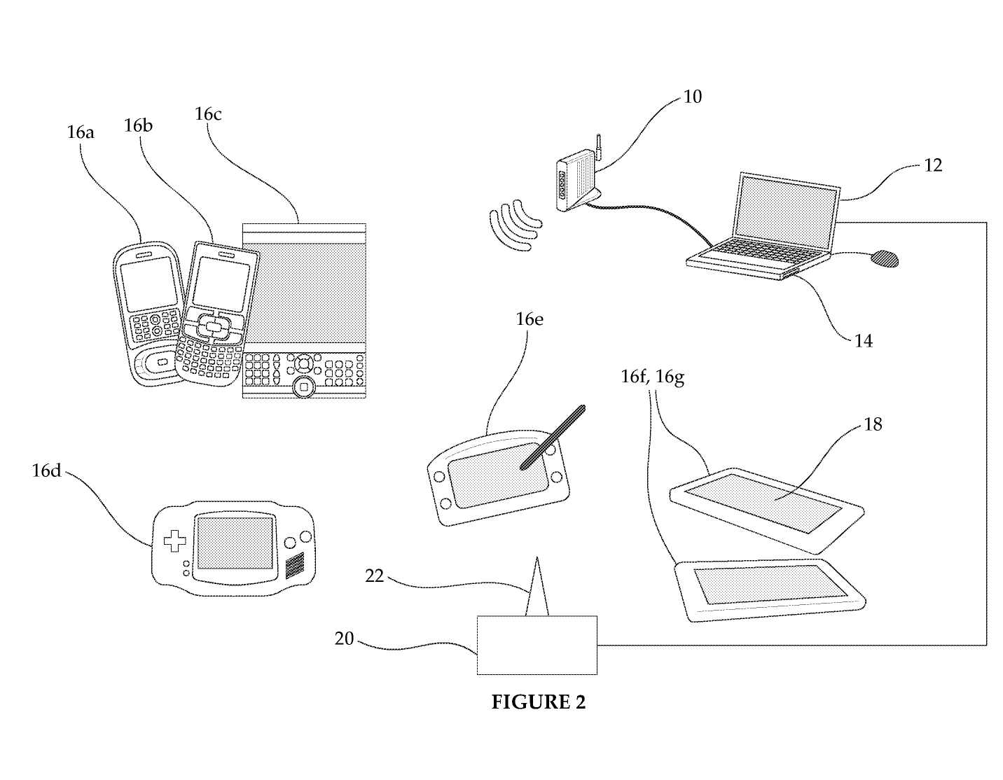

An additional embodiment, similar to the embodiment described with reference to FIG. 1, is described with reference to FIG. 2. In FIG. 2, content transmitter 10 is functionally associated with a system receiver 20 including antenna 22 through computer 12. Specifically, system receiver 20 is configured to receive data-packets transmitted by content transmitter 10 and forward these through a wired communication channel to computer 12. Computer 12 is configured to compare a data-packet transmitted by content transmitter 10 with the same data-packet as received by system receiver 20 in the usual way to evaluate the quality of service to system receiver 20 including such factors as noise in the vicinity of system receiver 20 and integrity of data transmission thereto.

Content transmitter 10 and computer 12 are configured to take various actions as quality of service deteriorates, including: when appropriate, increasing the aggressiveness of an applied FEC algorithm, increasing transmission power, or repetitive transmission of data-packets. When the actions taken are such that content transmitter 10 no longer has bandwidth available to transmit the HD format of all programs 1 to 7, computer 12 substitutes a regular format version for the HD format of at least one of programs 1 to 7. Which steps are taken at what quality of service threshold are easily determined by a person having ordinary skill in the art, or by trial and error.

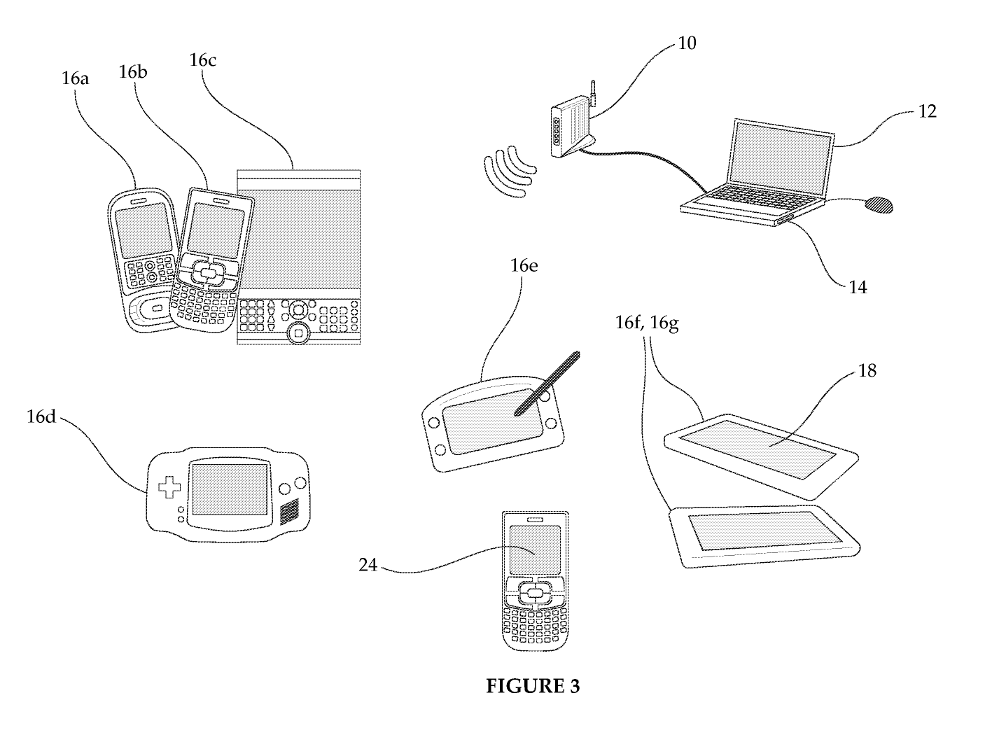

An additional embodiment, similar to the embodiment described with reference to FIGS. 1 and 2, is described with reference to FIG. 3. In FIG. 3, content transmitter 10 is functionally associated with a single system client 24, a Wi-Fi enabled smartphone.

In FIG. 3, both content transmitter 10 and system client 24 are configured to establish and maintain a substantially standard Wi-Fi session except that instead of using the identifier of system client 24 to maintain the Wi-Fi session (in the address-1 field for forward channel transmissions and in the address-2 field for reverse channel transmissions), the predetermined generic destination identifier is used instead.

During transmission of content, a Wi-Fi session is established and maintained in the usual way between content transmitter 10 and system client 24, where system client 24 acknowledges receipt of data-packets and content transmitter 10 retransmits data-packets for which no acknowledgment has been received.

In addition to maintaining a Wi-Fi session with system client 24, computer 12 and content transmitter 10 are configured to monitor quality of service as reflected in the number of data-packets retransmissions made by content transmitter 10 to system client 24, and to take various actions in addition to data-packet retransmission that takes place in the framework of the Wi-Fi sessions, for example as described above.

User-devices 16 function substantially as described above with reference to FIG. 1 and FIG. 2. When a user-device 16 receives a data-packet multiple times, e.g., as a result of receiving both the original and the re-transmission, user-device 16 ignores the unneeded data-packets with reference to the packet serial number.

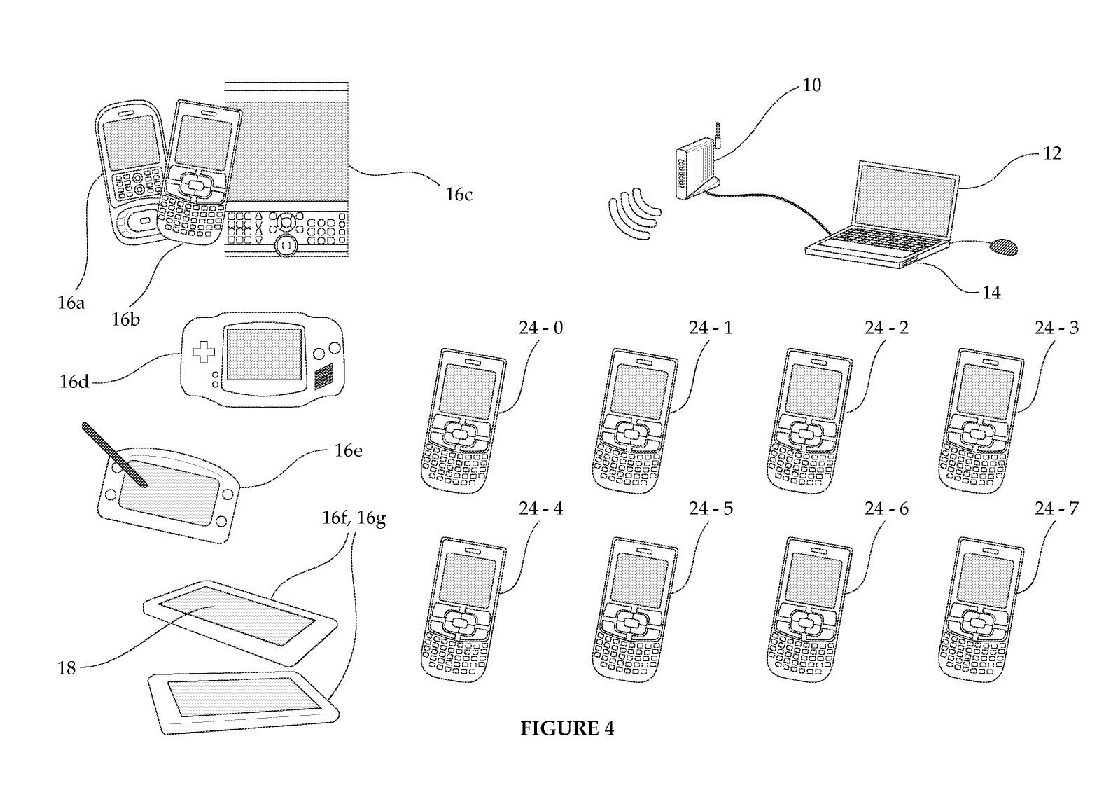

An additional embodiment, similar to the embodiments described with reference to FIGS. 1, 2 and 3, is described with reference to FIG. 4. In FIG. 4, content transmitter 10 is functionally associated with eight system clients 24-0, 24-1, 24-2, 24-3, 24-5, 24-6 and 24-7, each one a Wi-Fi enabled smartphone. Each one of system clients 24 is assigned to establish and maintain a single Wi-Fi session over which a single respective program is transmitted, that is to say, program 0 through the Wi-Fi session with system client 24-0, program 1 through the Wi-Fi session with system client 24-1, and so forth.

In FIG. 4, content transmitter 10 and system clients 24 are configured to establish and maintain substantially standard Wi-Fi sessions, specifically, where each system client 24 establishes and maintains a Wi-Fi session using an own identifier as known in standard Wi-Fi communication methods.

When adding a header (equivalent to a Wi-Fi MAC header) to a data-packet relating to a particular program, content transmitter 10 adds the device identifier of a respective system client 24 to the address-1 field, where the device identifier in the address-1 field functions as a program identifier, an own identifier to the address-2 field, the generic destination identifier, a guide program identifier and a FEC identifier to the address-3 field and a packet serial number to the address-4 field. Specifically, the device identifier of system client 24-0 is added to the address-1 field of all data-packets relating to program 0, the device identifier of system client 24-1 is added to the address-1 field of all data-packets relating to program 1, and so forth.

During transmission of content, eight Wi-Fi sessions are established and maintained in the usual way between content transmitter 10 and the eight system clients 24, where each one of system clients 24 acknowledges receipt of data-packets intended therefore and content transmitter 10 retransmits data-packets for which no acknowledgment has been received.

In addition to maintaining the Wi-Fi sessions with each one of system clients 24, computer 12 and content transmitter 10 are configured to monitor quality of service as reflected in the number of data-packet retransmissions made by content transmitter 10 to system clients 24, and to take various actions in addition to the data-packet retransmission that take place in the framework of the Wi-Fi sessions, in analogy to the described with reference to FIG. 3.

User-devices 16 function substantially as described above with reference to FIGS. 1, 2 and 3. A user-device 16 identifies the transmissions as transmissions in accordance with the teachings herein by the presence of the generic destination identifier in the address-3 field of the data-packet header and therefore does not attempt to initiate a Wi-Fi session with content transmitter 10 and instead automatically informs the user that content for consumption is available in accordance with the teachings herein. If the user is interested in consuming the content, user-device 16 identifies the guide program packets with reference to the guide program identifier in the address-3 field of the header.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention. Section headings are used herein to ease understanding of the specification and should not be construed as necessarily limiting.

1-56. (canceled)

57. A method of wireless transmission of content using Wi-Fi infrastructure, comprising:
a) providing a wireless content transmitter configured for transmission of data-packets using Wi-Fi infrastructure;
b) serially supplying a set of data-packets to said wireless content transmitter for wireless transmission, said set of data-packets constituting a program of content; and
c) said content transmitter serially wirelessly transmitting said data-packets of said set of data-packets using a Wi-Fi infrastructure, wherein:
prior to transmission of each said data-packet of said set of data-packets, said wireless content transmitter adding a header to said data-packet, said header including a predetermined generic destination identifier allowing a plurality of user-devices to access said data-packet, thereby transmitting each said data-packet of said set with said header.

58. The method of claim 57, wherein during said serial wireless transmission of said set of data-packets, said wireless content transmitter periodically transmitting a beacon frame.

59. The method of claim 57, wherein during said serial wireless transmission of said set of data-packets, said wireless content transmitter does not transmit a probe response to a probe request received from a user-device.

60. The method of claim 57, wherein during said serial wireless transmission of said data-packets, said wireless content transmitter does not transmit an association response to an association request received from a user-device.

61. The method of claim 57, wherein a said transmitted data-packet includes a program identifier.

62. The method of claim 61, prior to transmission of each said data-packet, said wireless content transmitter adding a said program identifier to said header.

63. The method of claim 61, wherein said data-packet supplied to said wireless content transmitter include a said program identifier.

64. The method of claim 57, wherein a said transmitted data-packet includes a data-packet serial number.

65. The method of claim 57, further comprising:
providing at least one system receiver configured to wirelessly receive said data-packets transmitted by said wireless content transmitter;
during said transmitting said data-packets, at least one said system receiver receiving at least some of said data-packets; and
said at least one system receiver reporting information relating to the quality of reception of said received data-packets,
wherein said reporting of information is through a non-Wi-Fi modality.

66. The method of claim 57, wherein during the wireless transmission of content, said wireless content transmitter maintains no Wi-Fi sessions.

67. The method of claim 57, further comprising:
providing at least one system-client configured to wirelessly receive said data-packets transmitted by said wireless content transmitter;
during said transmission of content, said content transmitter maintaining at least one Wi-Fi session with at least one of said system-clients; and
during said transmission of content, upon receipt of a transmitted data-packet by a said system-client with a said maintained Wi-Fi session, said system-client acknowledging receipt of said received data-packet, wherein said acknowledgment is performed as part of said Wi-Fi session between said system-client and said content transmitter.

68. The method of claim 67, including a single said system-client, and wherein during said wireless transmission of content the only Wi-Fi session said content transmitter maintains is with said single system-client.

69. The method of claim 67, including at least two said system-clients, and during said wireless transmission of content said content transmitter maintains a said Wi-Fi session with each one of said system-clients.

70. A device suitable for wireless transmission using Wi-Fi infrastructure, comprising a wireless content transmitter for wirelessly transmitting content in accordance with the method of claim 57.

71. The device of claim 70, wherein said wireless content transmitter is configured to:
serially receive a set of data-packets constituting a program of content; and
serially wirelessly transmit said data-packets of said set of data-packets using a Wi-Fi infrastructure,
wherein said wireless content transmitter is configured to, prior to transmission of each said data-packet of said set of data-packets, add a header to said data-packet, said header including a predetermined generic destination identifier allowing a plurality of user-devices to access said data-packet.

72. A method of receiving data-packets transmitted over a Wi-Fi infrastructure, comprising:
a) with a user-device, scanning Wi-Fi frequencies for Wi-Fi transmissions to identify beacon frames;
b) upon identifying a transmitted beacon frame, synchronizing said user-device with a transmitter of said beacon frame; and
c) subsequently to said synchronizing:
i. interrogating data-packets transmitted by said transmitter for the presence of a predetermined generic destination identifier; and
ii. if a said transmitted data-packet includes a said predetermined generic destination identifier, processing said data-packet to recover data therefrom without establishing a Wi-Fi session with said transmitter.

73. The method of claim 72, further comprising:
interrogating a said data-packet transmitted by said transmitter for the presence of a program identifier; and
if said data-packet includes a desired said program identifier, processing said data-packet to recover data therefrom.

74. The method of claim 72, further comprising:
interrogating a said data-packet transmitted by said transmitter for the presence of a packet serial number; and
if said data-packet includes a packet serial number indicating that data in said data-packet has already been received for said processing, ignoring said data-packet.

75. A method comprising:
providing a communication channel allowing access to software configured to allow a Wi-Fi enabled user-device to implement a method of receiving data-packets in accordance with the method of claim 72.

76. The method of claim 75, further comprising:
upon receipt of a command, transferring said software to a designated location.
